(19) United States
(12) Patent Application Publication
(10) Pub. No.: US 2026/0365118 A1
(43) Pub. Date: Nov. 19, 2026

(54) SELECTIVELY DEPLOYABLE VEHICLE ROOF RAIL ASSEMBLY HAVING POWER DELIVERY INTERFACE

(71) Applicant: Ford Global Technologies, LLC, Dearborn, MI (US)

(72) Inventors: Joseph Ian Halaszynski, Farmington Hills, MI (US); Jacob Michael Haspiel, Ann Arbor, MI (US); John Galin, Mill Valley, CA (US)

(21) Appl. No.: 19/207,462

(22) Filed: May 14, 2025

(51) Int. Cl. B60R 9/10; B60Q 1/24; B60R 11/00

(52) U.S. Cl. CPC B60R 9/10; B60Q 1/247; B60R 2011/0084

(57) ABSTRACT

A vehicle system includes a roof rail assembly that is movable between a retracted position and a deployed position. At least one power delivery interface is provided within the roof rail assembly. At least one light is provided within the roof rail assembly. A vehicle system includes a roof rail assembly having a crossbar spanning between a plurality of support pillars. The roof rail assembly is transitionable between a retracted position and a deployed position. At least one power delivery interface is within at least one of the support pillars.

### TECHNICAL FIELD

This disclosure relates to a vehicle having a selectively deployable roof rail assembly with at least one power delivery interface.

### BACKGROUND

Some motor vehicles include roof rail assemblies, including side rails and crossbars, which can be used as mounting points for gear, such as luggage or sporting equipment.

### SUMMARY

In some aspects, the techniques described herein relate to a vehicle system, including: a roof rail assembly that is movable between a retracted position and a deployed position; at least one power delivery interface provided within the roof rail assembly; and at least one light provided within the roof rail assembly.

In some aspects, the techniques described herein relate to a vehicle system, wherein the at least one light is concealed when the roof rail assembly is in the retracted position and exposed when the roof rail assembly is in the deployed position.

In some aspects, the techniques described herein relate to a vehicle system, wherein the at least one power delivery interface includes an electrical outlet.

In some aspects, the techniques described herein relate to a vehicle system, wherein the roof rail assembly includes a rail spanning between a plurality of support pillars.

In some aspects, the techniques described herein relate to a vehicle system, wherein the at least one power delivery interface is provided within at least one of the support pillars.

In some aspects, the techniques described herein relate to a vehicle system, further including at least one light provided within at least one of the support pillars.

In some aspects, the techniques described herein relate to a vehicle system, wherein the at least one light is configured to emit light to an outboard side of a vehicle when the roof rail assembly is in deployed position.

In some aspects, the techniques described herein relate to a vehicle system, further including at least one light provided within a forward-facing edge of the rail.

In some aspects, the techniques described herein relate to a vehicle system, wherein the roof rail assembly and the support pillars are configured to fit within a recess formed by a vehicle roof when the roof rail assembly is in the retracted position.

In some aspects, the techniques described herein relate to a vehicle system, wherein an upper surface of the rail is substantially flush with an adjacent portion of a vehicle roof when the roof rail assembly in the retracted position.

In some aspects, the techniques described herein relate to a vehicle system, further including at least one actuator that moves the roof rail assembly back and forth between the deployed position and the retracted position.

In some aspects, the techniques described herein relate to a vehicle system, wherein the roof rail assembly is a crossbar assembly.

In some aspects, the techniques described herein relate to a vehicle system, wherein the roof rail assembly is a side rail assembly.

In some aspects, the techniques described herein relate to a vehicle system, including: a roof rail assembly having a crossbar spanning between a plurality of support pillars, the roof rail assembly transitionable between a retracted position and a deployed position; and at least one power delivery interface within at least one of the support pillars.

In some aspects, the techniques described herein relate to a vehicle system, further including at least one light provided within the roof rail assembly.

In some aspects, the techniques described herein relate to a vehicle system, wherein the at least one light is provided within at least one of the support pillars.

In some aspects, the techniques described herein relate to a vehicle system, wherein the at least one light is provided within the crossbar.

In some aspects, the techniques described herein relate to a vehicle system, wherein the at least one light is concealed when the roof rail assembly is in the retracted position.

In some aspects, the techniques described herein relate to a vehicle system, wherein the at least one power delivery interface includes an inductive power transfer pad configured to wirelessly transfer power from the crossbar to an accessory.

In some aspects, the techniques described herein relate to a vehicle system, wherein the at least one power delivery interfaces includes at least one power outlet, the at least one power outlet received within a recess formed by a vehicle roof when the roof rail assembly is in the retracted position.

In some aspects, the techniques described herein relate to a method, wherein the rail is spaced-apart above the roof in the deployed position.

### BRIEF DESCRIPTION OF THE DRAWINGS

FIG. 1 is a perspective view of an example motor vehicle including roof rail assemblies in a retracted position. In FIG. 1, the roof rail assemblies are configured as crossbars assemblies.

FIG. 2 is a perspective view of the example motor vehicle of FIG. 1 including the roof rail assemblies in deployed positions.

FIG. 3 is a perspective view of the example motor vehicle of FIG. 1 including roof rail assemblies in the deployed positions and an accessory connected to the roof rail assemblies.

FIG. 4 is a perspective view of the example motor vehicle of FIG. 1 according to an exemplary embodiment where a light is provided in a forward-facing side of a rail of one of the roof rail assemblies.

FIG. 5 is a perspective view of the example motor vehicle of FIG. 1 according to another exemplary embodiment where a light is provided in support pillars the roof rail assemblies.

FIG. 6 is a top perspective of the example motor vehicle with the roof rail assemblies in a deployed position.

FIG. 7 is the view of FIG. 6 with a cap of one of the roof rail assemblies expanded.

FIG. 8 is a top perspective view of the example motor vehicle having a roof rail assembly according to another exemplary embodiment of the present disclosure.

FIG. 9 is a top view of a motor vehicle according to another exemplary embodiment where the roof rail assemblies are side rails assembly.

### DETAILED DESCRIPTION

This disclosure relates to a motor vehicle with selectively deployable roof rails that can provide lighting and, optionally, power delivery interfaces.

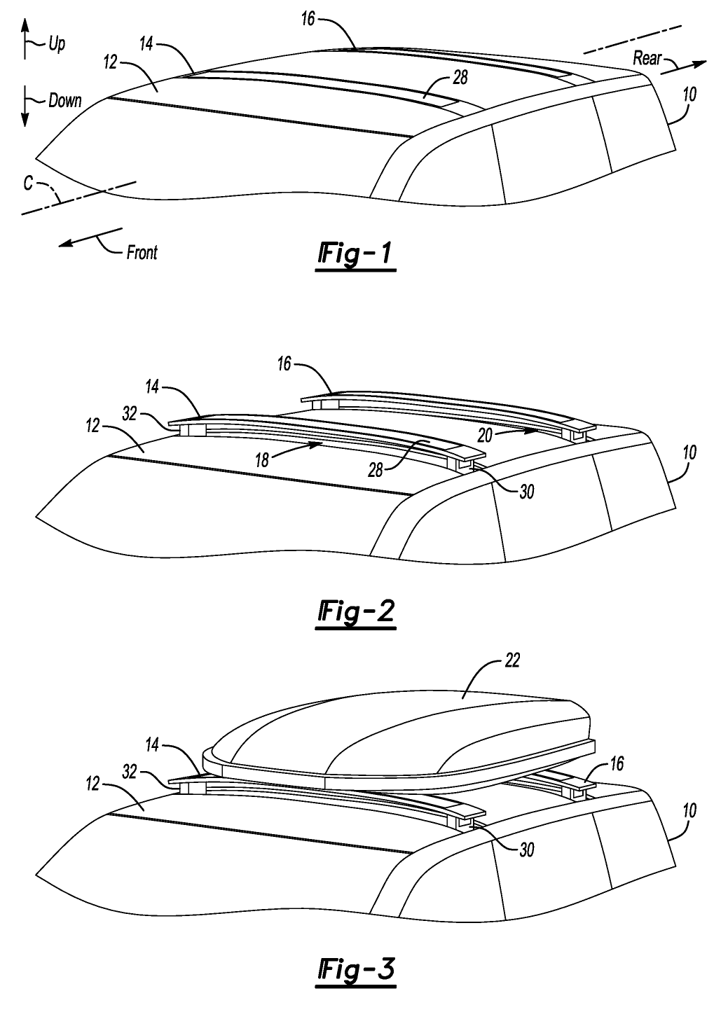

Referring to the drawings, FIG. 1 is a front-perspective view (the “front” and “rear” directions are labeled in FIG. 1 for reference) of a portion of a motor vehicle 10 (“vehicle 10”). Specifically, FIG. 1 shows the roof 12 of the vehicle 10. The roof 12 is the structure forming the upper covering of the vehicle 10, and is provided by metal, plastic, or glass panels, or a combination of one or more of metal, plastic, and glass panels. The roof 12 exhibits a length in a direction parallel to a centerline C of the vehicle 10 and a width in a direction perpendicular to the centerline C.

In the exemplary embodiment, the vehicle 10 includes a pair of roof rail assemblies that are each movable vertically relative to the roof 12 between a retracted position and a deployed position. The vertical direction is a direction substantially normal to a ground surface upon which the vehicle 10 sits, such as dirt, grass, concrete, etc. The term “substantially” is used to account for slight variations relative to a true vertical direction, such as those brought about by tolerances and/or uneven ground surfaces, as examples. The “up” and “down” directions are vertical directions and are labeled in FIG. 1 for ease of reference.

In this example, the vehicle 10 includes first and second roof rail assemblies 14, 16. The first and second roof rail assemblies 14, 16 are spaced-apart from one another along the length of the roof 12, and are arranged adjacent a front end and a rear end of the roof 12, respectively. The first and second roof rail assemblies 14, 16 exhibit lengths extending in a direction perpendicular to the centerline C, and are sized such that the first and second roof rail assemblies 14, 16 extend generally from one side of the roof 12 to another. The first and second roof rail assemblies 14, 16 may be referred to as crossbar assemblies as the roof rail assemblies 14, 16 extend longitudinally in a cross-vehicle direction. The first and second roof rail assemblies 14, 16 may also together or separately be referred to as a roof rack.

The first and second roof rail assemblies 14, 16 are selectively deployable between a retracted position, as shown in FIG. 1, and a deployed position, as shown in FIG. 2. In this example, in the retracted position of FIG. 1, upper surfaces of the first and second roof rail assemblies 14, 16 are substantially flush with an adjacent portion of the roof 12. In this disclosure, substantially flush means the upper surfaces of the first and second roof rail assemblies 14, 16 are substantially level, and co-planar with, an adjacent portion of the roof 12.

As shown in FIG. 2, the roof 12 includes first and second recesses 18, 20 or pockets that are sized and shaped to receive the roof rail assemblies 14, 16. When the first and second roof rail assemblies 14, 16 are in the retracted position, the first and second roof rail assemblies 14, 16 are at least partially within the respective first and second recesses 18, 20. Again, in a particular example, in the retracted position the upper surfaces of the first and second roof rail assemblies 14, 16 are substantially flush with an adjacent portion of the roof 12. Permitting retraction to a substantially flush position provides a number of benefits, including increased aerodynamics. In some examples, the first and second roof rail assemblies 14, 16 can be moved to a deployed position to facilitate aerodynamics. The first and second roof rails assemblies 14, 16 can be moved to a deployed position that stops short of a fully deployed position. That is, the first and second roof rails assemblies 14, 16, to facilitate aerodynamics, could be moved to a one of a plurality of deployed positions that are between a fully deployed position and the retracted position.

The first and second recesses 18, 20 may correspond to, and be provided at least partially within, cross-car beams or other structures of the body of the vehicle 10. The first and second roof rail assemblies 14, 16 are movable vertically relative to the roof 12 to the deployed position, in which the first and second roof rail assemblies 14, 16 are able to connect to and at least partially support an accessory 22, which is arranged above the roof 12, as shown in FIG. 3.

In FIG. 3, the accessory 22 is a car top carrier. The first and second roof rail assemblies 14, 16, however, can connect to a number of other types of accessories, including racks configured to support items such as kayaks, skis, bicycles, etc. The first and second roof rail assemblies 14, 16 can also directly connect to accessories such as kayaks, skis, bicycles, etc., without an intervening, specialized rack. The first and second roof rail assemblies 14, 16 can also connect to various electronic accessories, including sensors, heaters, etc., some examples of which will be discussed below.

The first roof rail assembly 14 includes a rail 28 spanning between a driver side support pillar 30 and a passenger side support pillar 32. At least one actuator can be used to move the first roof rail assembly 14 back and forth between the deployed position and the retracted position. In this example, the at least one actuator comprises a screw gear, although this disclosure extends to other types of actuators. For example, the at least one actuator could instead be provided in part by a compact linear actuator, a ball screw actuator, a four-bar linkage, or a planetary gear mechanism. The at least one actuator can hold the first roof rail assembly 14 in the retracted position or the deployed position.

The second roof rail assembly 16 is configured similarly to the first roof rail assembly 14. At least one actuator can be used to move the second roof rail assembly 16 back and forth between the deployed position and the retracted position. Movements of the first roof rail assembly 14 and second roof rail assembly 16 may be synchronized.

In an example, a user could cause transitions of the first roof rail assembly 14 and second roof rail assembly 16 by initiating a command on a keyfob, on mobile device of the user, by a button on an exterior of the vehicle 10, and/or by a user interface in a passenger cabin. Movement of the first roof rail assembly 14 and the second roof rail assembly 16 can be synchronized.

The at least one actuator can cause the first roof rail assembly 14 to move in response to commands from a controller, which may be part of an overall vehicle control module, such as a vehicle system controller (VSC), or could alternatively be a stand-alone controller separate from the VSC. The controller may be programmed with executable instructions for interfacing with and operating the various components of the vehicle 10. The controller additionally includes a processing unit and non-transitory memory for executing the various control strategies and modes of the vehicle 10.

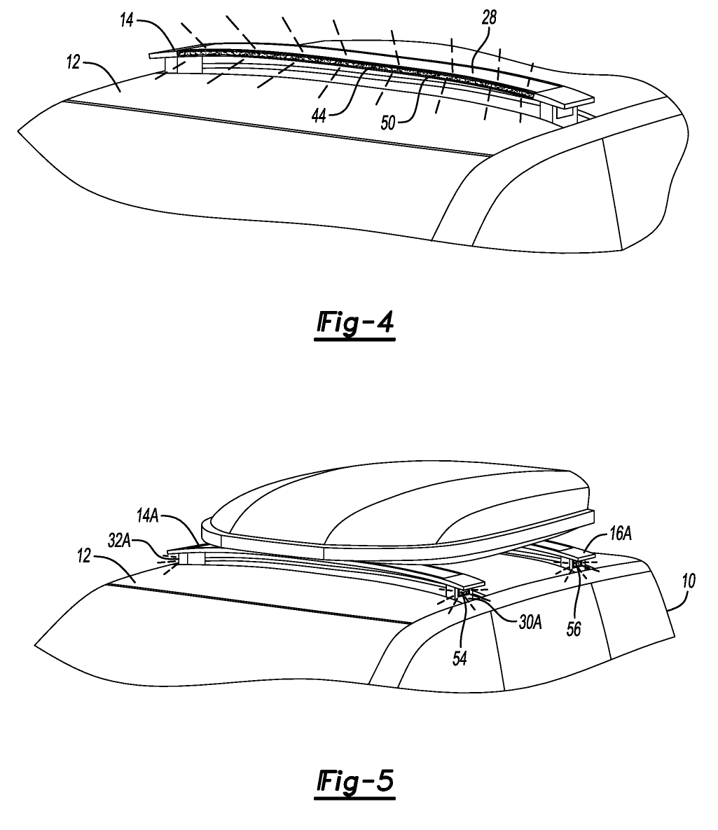

With reference to FIG. 4 and continuing reference to FIGS. 1–3, in the exemplary embodiment, the first roof rail assembly 14 includes a light 50 that is provided within the rail 28 and, more particularly, within a forward-facing edge 44 of the rail 28. When the first roof rail assembly 14 is in the deployed position, the light 50 is exposed and can be activated to illuminate areas forward of the vehicle 10. The light 50 is received within the first recess 18 and concealed when the first roof rail assembly 14 is in the retracted position. That is, the light 50 is not visible to an observer when the first roof rail assembly 14 is in the retracted position.

With reference to FIG. 5 and continuing reference to FIGS. 1–3, in another exemplary embodiment, a driver side support pillar 30A and a passenger side support pillar 32A of a first roof rail assembly 14A each include a light 54. When the first roof rail assembly 14A is in the deployed position, the light 54 can be activated to emit light to the outboard sides of the vehicle 10. The light 54 is received within the first recess 18 and concealed when the first roof rail assembly 14A is in the retracted position. That is, the light 54 is not visible to an observer when the first roof rail assembly 14A is in the retracted position. A second roof rail assembly 16A can be equipped with lights 56 that also can be activated to emit light to the outboard sides of the vehicle 10.

While the first roof rail assembly 14 of FIG. 4 includes the light 50 in the rail 28, and the first roof rail assembly 14A of FIG. 5 includes the lights 54 in driver side support pillar 30A and the passenger side support pillar 32A, embodiments are contemplated where a single roof rail assembly could include at least one light in a rail and at least one light in each support pillar.

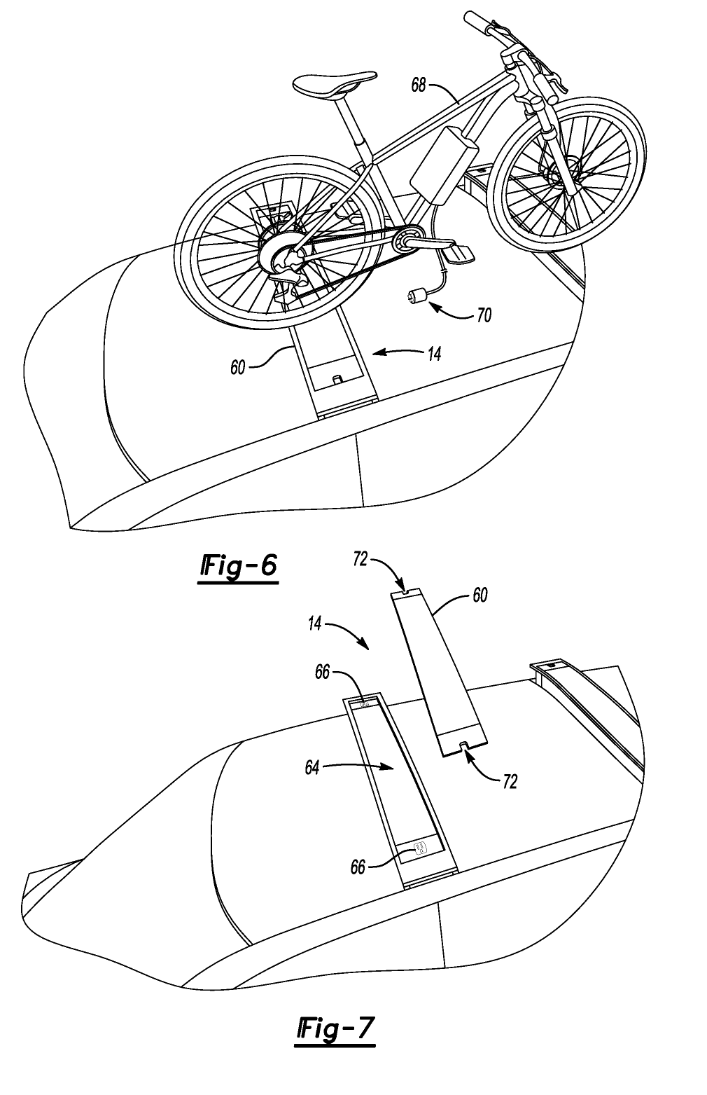

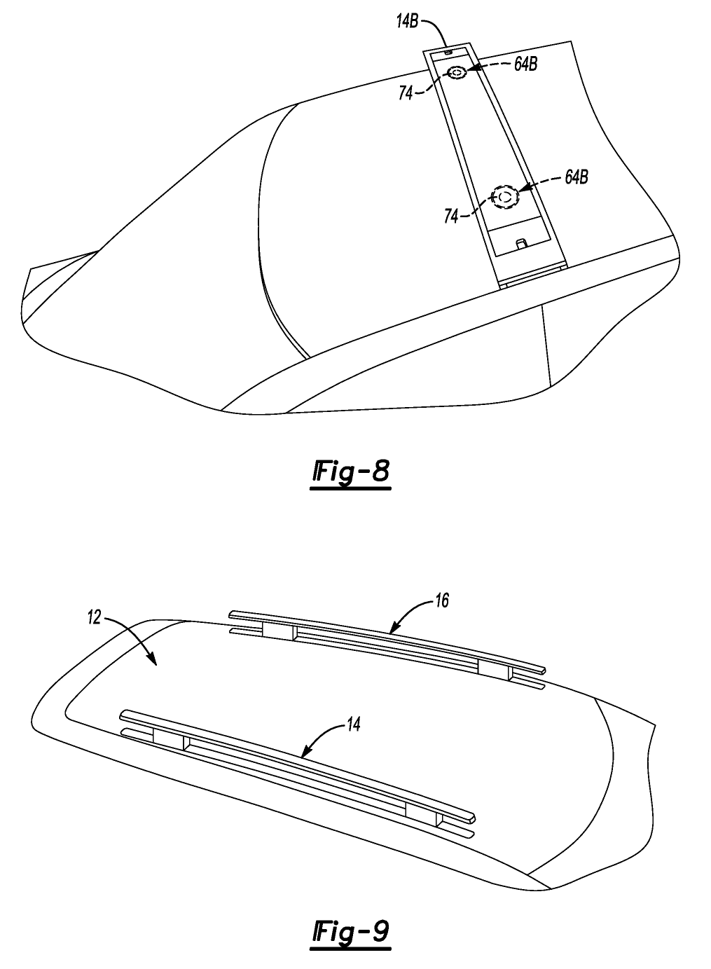

Referring now to FIGS. 6 and 7, the first roof rail assembly 14 includes a cap 60 that covers a pocket 64 of the first roof rail assembly 14. At least one power delivery interface 66 is disposed within the pocket 64. The example power delivery interface 66 is an electrical outlet.

An accessory 68 mounted to the roof 12 can be powered through the at least one power delivery interface 66. In this example, the accessory 68 is an electric bicycle mounted to the first roof rail assembly 14. A charging assembly associated with the electric bicycle can include a plug 70.

The example power delivery interface 66 includes a socket portion configured to receive prongs of the plug 70 and deliver power to the electric bicycle through the at least one power delivery interface 66. A battery of the electric bicycle can then be recharged through the at least one power delivery interface 66 from a power source of the vehicle 10, such as an accessory battery or a traction battery of the vehicle 10.

The example cap 60 can include clearance notches 72 that permit the plug 70 to engage with one of the power delivery interfaces 66 when the cap 60 is moved back to the installed position. The at least one power delivery interface 66 can be accessible and useable when the first roof rail assembly 14 is in the retracted position or the deployed position.

While the example at least one power delivery interface 66 is within the pocket 64 provided by the rail 28, the at least one power delivery interface 66 could instead or additionally be provided within the driver side support pillar 30 or the passenger side support pillar 32. Moving the first roof rail assembly 14 to the retracted position can conceal the at least one power delivery interface 66 provided within the driver side support pillar 30 or the passenger side support pillar 32.

Referring now to FIG. 8, in another exemplary embodiment, a roof rail assembly 14B can include a power delivery interface 64B provided by at least one inductive power transfer pad 74. In this example, the first roof rail assembly 14B, on an upper surface thereof, includes one of the inductive power transfer pads 74 on a driver side and one on a passenger side. The pads 74 may be made of a rubber or polymer material, as examples. An accessory can receive power from a power supply of the vehicle 10 wirelessly delivered through the pads 74. The roof rail assembly 14B can be in the deployed position or the retracted position when power is delivered through the pads 74.

While the first and second roof rail assemblies 14, 16 extend perpendicular to the vehicle centerline C in FIGS. 1–8, the first and second roof rail assemblies 14, 16 could be configured such that lengths of the first and second roof rail assemblies 14, 16 are arranged parallel to the centerline C and such that the first and second roof rail assemblies 14, 16 extend along sides of the roof 12, as shown in FIG. 9.

The first and second roof rail assemblies 14, 16 of the FIG. 9 embodiment are movable in substantially the same manner as described above and are configured to support an accessory 22 when in the deployed position as above. The first and second roof rail assemblies 14, 16 can each include at least one light and at least one power delivery interface as described in connection with the embodiments of FIGS. 1–8. The first and second roof rail assemblies 14, 16 of FIG. 9 may be referred to as roof rails, side rails, or a roof rack.

Directional terms such as “upward,” “above,” “downward,” “under,” “below,” “side,” “inside,” “outside,” “horizontal,” etc., are used herein with reference to the normal operational attitude of a vehicle. It should be understood that terms such as “slightly,” “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various FIGs accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A vehicle system, comprising:
a roof rail assembly that is movable between a retracted position and a deployed position;
at least one power delivery interface provided within the roof rail assembly; and
at least one light provided within the roof rail assembly.

2. The vehicle system of claim 1, wherein the at least one light is concealed when the roof rail assembly is in the retracted position and exposed when the roof rail assembly is in the deployed position.

3. The vehicle system of claim 1, wherein the at least one power delivery interface comprises an electrical outlet.

4. The vehicle system of claim 1, wherein the roof rail assembly comprises a rail spanning between a plurality of support pillars.

5. The vehicle system of claim 4, wherein the at least one power delivery interface is provided within at least one of the support pillars.

6. The vehicle system of claim 5, further comprising at least one light provided within at least one of the support pillars.

7. The vehicle system of claim 6, wherein the at least one light is configured to emit light to an outboard side of a vehicle when the roof rail assembly is in deployed position.

8. The vehicle system of claim 5, further comprising at least one light provided within a forward-facing edge of the rail.

9. The vehicle system of claim 4, wherein the roof rail assembly and the support pillars are configured to fit within a recess formed by a vehicle roof when the roof rail assembly is in the retracted position.

10. The vehicle system of claim 4, wherein an upper surface of the rail is substantially flush with an adjacent portion of a vehicle roof when the roof rail assembly in the retracted position.

11. The vehicle system of claim 1, further comprising at least one actuator that moves the roof rail assembly back and forth between the deployed position and the retracted position.

12. The vehicle system of claim 1, wherein the roof rail assembly is a crossbar assembly.

13. The vehicle system of claim 1, wherein the roof rail assembly is a side rail assembly.

14. A vehicle system, comprising:
a roof rail assembly having a crossbar spanning between a plurality of support pillars, the roof rail assembly transitionable between a retracted position and a deployed position; and
at least one power delivery interface within at least one of the support pillars.

15. The vehicle system of claim 14, further comprising at least one light provided within the roof rail assembly.

16. The vehicle system of claim 15, wherein the at least one light is provided within at least one of the support pillars.

17. The vehicle system of claim 15, wherein the at least one light is provided within the crossbar.

18. The vehicle system of claim 15, wherein the at least one light is concealed when the roof rail assembly is in the retracted position.

19. The vehicle system of claim 14, wherein the at least one power delivery interface comprises an inductive power transfer pad configured to wirelessly transfer power from the crossbar to an accessory.

20. The vehicle system of claim 14, wherein the at least one power delivery interfaces comprises at least one power outlet, the at least one power outlet received within a recess formed by a vehicle roof when the roof rail assembly is in the retracted position.
